(19) United States
(12) Patent Application Publication
(10) Pub. No.: US 2009/0256747 A1
(43) Pub. Date: Oct. 15, 2009

(54) SIGNAL RECEIVING SYSTEM

(75) Inventors: Eiji Shibuya, Kobe-shi (JP); Takayuki Yoshii, Kobe-shi (JP)

Correspondence Address: DUANE MORRIS LLP - Philadelphia;IP DEPARTMENT, 30 SOUTH 17TH STREET, PHILADELPHIA, PA, 19103-4196, US

(73) Assignee: DX ANTENNA COMPANY, LIMITED, Kobe-shi (JP)

(21) Appl. No.: 12/422,002

(22) Filed: Apr. 10, 2009

(30) Foreign Application Priority Data
Apr. 14, 2008 (JP) 2008-104476

(51) Int. Cl. H04B 7/00

(52) U.S. Cl. 342/367

(57) ABSTRACT

A variable directivity antenna (2) has directivity direction angularly variable stepwise about itself. A tuner (8) selects a desired one from high frequency signals received at the antenna (2). The tuner (8) detects the level of the received signal and supplies it to a control unit (10). The control unit (10) searches for received signal levels, equal to or higher than a threshold level, of the received signal received in plural states in which the directivity of the antenna (2) is placed in different ones of directivity directions, and detects a slope of the received signal levels within a frequency range of the received signal. The control unit (10) employs the searched directivity direction for the smallest one of the detected slopes as the direction to which the antenna (2) is directed to receive the signal.

This invention relates to a signal receiving system and, more particularly, to a signal receiving system used with a variable directivity antenna.

### BACKGROUND OF THE INVENTION

An example of signal receiving systems used with a variable directivity antenna is disclosed in Patent Literature 1. According to the technique disclosed in Patent Literature 1, the direction in which a variable directivity antenna exhibits its directivity can be successively changed in the circumferential direction at predetermined angular intervals.

### [Patent Literature]

[Patent Literature 1] U.S. Pat. No. 7,277,063 B2

In order to receive a desired signal wave with such a variable directivity antenna, the direction of the antenna directivity is successively changed, and the level of the desired signal wave received in the respective directions is detected. The direction of directivity in which the received signal level is at or above a given threshold may be adopted as the orientation of the antenna. If, however, the variable directivity antenna is under multi-path (multiple-path) influence, the received signal level may be equal to or above the given threshold although the antenna directivity is not in the true direction in which the desired signal wave comes to the antenna, so that an improper direction is adopted as the orientation of the antenna. For example, when a wave of a particular terrestrial digital broadcast channel is received by an antenna with its directivity set in a wrong direction, block noise may appear in a displayed picture or, sometimes, a picture may black out due to degradation of a signal-to-noise ratio (S/N) and/or a bit error rate (BER). If the orientation of a variable directivity antenna is set improperly when installing the antenna first time, terrestrial digital broadcast waves cannot be received in a good condition so that pictures with block noise will be always displayed and/or the pictures may be blacked out if no manual control for that particular channel is made.

An object of the present invention is to provide a signal receiving system which can prevent the directivity direction of a variable directivity antenna from being set to an improper direction.

### SUMMARY OF THE INVENTION

According to an aspect of the present invention, a signal receiving system includes a variable directivity antenna. The variable directivity antenna has a directivity direction variable stepwise along a circumference of a circle centered about the antenna. The direction of directivity may be changed by, for example, mechanically changing the orientation of the antenna. Alternatively, the variableness of antenna directivity may be obtained by, for example, forming an antenna with a plurality of antenna elements, e.g. dipole antenna elements, mechanically arranging the antenna elements to exhibit different directivity directions, for example, disposing them to cross orthogonally with each other, and adjusting the levels of signals received at the respective antenna elements by level adjusting means or electrically altering the phases of the received signals, before combining them, to thereby electrically vary the directivity direction without need for changing the orientation of the antenna. Signal receiving means selectively receives a desired one of high-frequency signals received by the variable directivity antenna. It is desirable that the high-frequency signals have a predetermined frequency range and exhibit generally constant received signal level over the entire frequency range. The signal receiving means may include tuning means for selecting a signal wave at a desired frequency. The tuning means may be arranged to be selectively tunable to different frequencies. The level of the signal received by the signal receiving means is detected by level detecting means. The level detecting means may be arranged to detect the level of a high frequency signal as selected by the signal receiving means. Alternatively, when the system is arranged such that the high frequency signal received by the signal receiving means is frequency-translated to an intermediate frequency signal before demodulation, the level detecting means may detect the level of the intermediate frequency signal or detect the demodulated signal. Searching means searches the received signals developed in a plurality of states in which the variable directivity antenna is placed in different directivity directions, for a plurality of signals having a level equal to or higher than a predetermined threshold. Comparing means may be used as the searching means, which compares the level of the received signals with the predetermined threshold. Different received signals are successively supplied to the searching means. Slope detecting means detects the slope between a plurality of received signal levels of each of the searched received signals within the frequency range. Judging means judges that the searched directivity direction corresponding to the smallest one of the detected slopes should be the direction for the variable directivity antenna to receive the signal.

If, for example, because of multi-path influence, received signal levels are above a predetermined threshold level although the directivity of the antenna is placed in a direction different from the correct one, from which the desired wave comes, the received signal levels at respective frequencies within the frequency range of that received signal are not constant because of multi-path influence, but there are slopes formed between the received signal levels. For example, the received signal level at the center of the frequency range may dip, or the signal level may be largest at a frequency in the lower part of the frequency range, decreasing toward a frequency in the upper part of the frequency range, or, conversely, it may be largest at a frequency in the upper part of the frequency range, decreasing toward a frequency in the lower part of the frequency range. The slope detecting means is employed to detect slopes between received signal levels within a frequency range of a received signal in a plurality of directions in which the received signal levels are above a predetermined threshold level. The direction for the smallest one of the slopes is judged to be the correct direction from which the desired wave comes, and the directivity is oriented to the judged direction.

It is desirable that the slope detecting means be arranged to detect the slope, using received signal levels on opposite sides of the center frequency of the frequency range.

As described above, when the received signal levels are above a predetermined threshold level, it frequently occurs that the received signal level at the center of the frequency range may dip, or the received signal level may be largest at a frequency in the lower part of the frequency range, decreasing toward a frequency in the upper part of the frequency range, or, conversely, it may be largest at a frequency in the upper part of the frequency range, decreasing toward a frequency in the lower part of the frequency range. Accordingly, detecting the slope using the received signal levels on opposite sides of the center frequency can surely avoid setting the variable directivity antenna directivity direction to an erroneous direction.

The slope detecting means, when there are more than or equal to a predetermined number of received signal levels equal to or higher than the predetermined threshold level, may be arranged to detect the slopes for the predetermined number of received signal levels selected in the order of the magnitude of the received signal levels higher or equal to the threshold level, the highest one first. When there are many signals received with levels higher than the threshold level, a long time is required for determining the slopes for all of such signals. Generally, when the received signal level is higher, the stronger is the possibility of the searched directivity direction being the correct direction from which the desired signal wave comes. Then, if there are more than a predetermined number of the received signal levels equal to or above the threshold level, the slopes between the predetermined number of signal levels selected in the order of the magnitude, the largest first, are determined, so that the time required for determining the orientation of the variable directivity antenna can be short,

The signal receiving means or the variable directivity antenna may be provided with amplifying means. The amplifying means operates to amplify the high frequency signals received by the variable directivity antenna or the received signal at the signal receiving means when no signals have a level equal to or higher than the threshold level, or operates when the number of signals having a level equal to or higher than the threshold level is smaller than the predetermined number. The amplified high frequency signal is applied to the signal receiving means, or the amplified received signal is applied to the level detecting means and to the slope detecting means. The slope detecting means and the judging means operate in the manner as described previously.

With the described arrangement, if the high frequency signal has a low level, for example, the high frequency signal itself or the signal at the signal receiving means is amplified to have a level equal to or higher than the threshold level, which increases the feasibility of preventing the directivity direction of the variable directivity antenna from being set to a wrong direction.

### EFFECT OF THE INVENTION

As described above, the present invention can surely avoid setting the direction of the directivity of a variable directivity antenna to an erroneous direction.

### BRIEF DESCRIPTION OF THE DRAWINGS

FIG. 1 is a block diagram of a signal receiving system according to an embodiment of the present invention.

FIG. 2 is a block diagram of a variable directivity antenna used in the signal receiving system of FIG. 1.

FIG. 3 shows how the directivity of the variable directivity antenna changes in the signal receiving system of FIG. 1, and also received signal levels at particular directions.

FIG. 4 is a flow chart of a first part of the direction setting processing to be executed in the signal receiving system of FIG. 1.

FIG. 5 is a flow chart of a second part of the direction setting processing to be executed in the signal receiving system of FIG. 1.

FIG. 6 shows a basic waveform of a terrestrial digital broadcast signal to be received by the signal receiving system of FIG. 1.

FIGS. 7a, 7b, 7c and 7d show received signal waveforms of terrestrial digital broadcast signal obtained when it is actually received by the signal receiving system of FIG. 1.

FIG. 8 is a flow chart of a third part of the direction setting processing to be executed in the signal receiving system of FIG. 1.

FIG. 9 is a flow chart of a fourth part of the direction setting processing to be executed in the signal receiving system of FIG. 1.

FIG. 10 is a flow chart of a fifth part of the direction setting processing to be executed in the signal receiving system of FIG. 1.

### BEST MODE FOR CARRYING OUT THE INVENTION

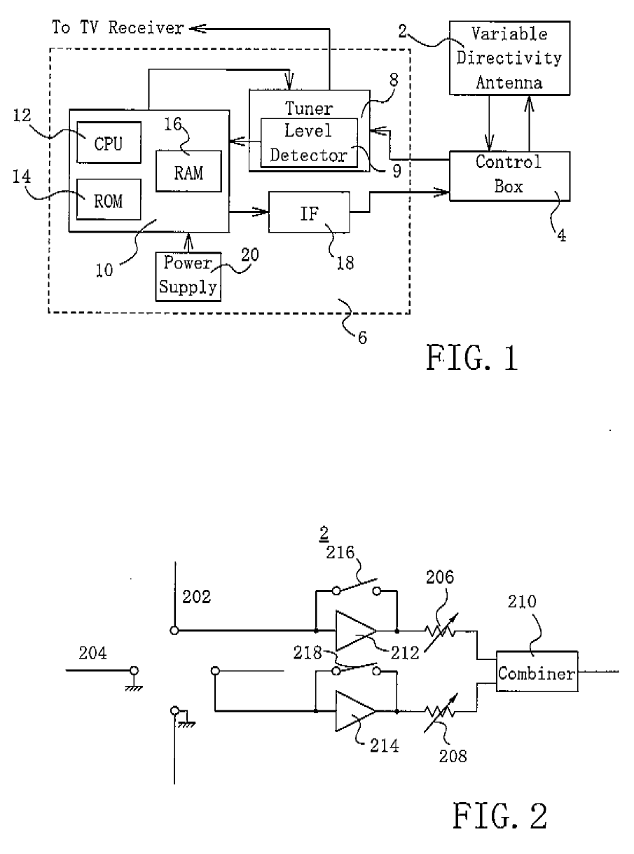

A signal receiving system according to one embodiment of the invention is a signal receiving system for receiving UHF-band terrestrial digital broadcast signals. The signal receiving system includes a variable directivity antenna 2 as shown in FIG. 1.

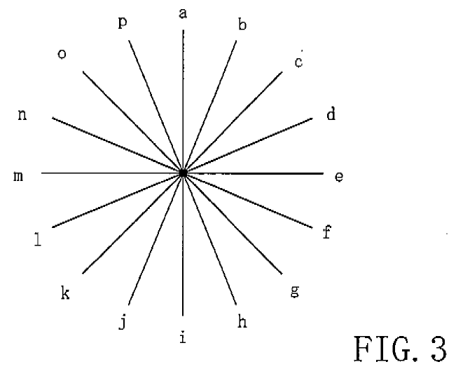

The variable directivity antenna 2 may be an antenna disclosed in, for example, WO 2004/091043, which includes a plurality, e.g. two, of antenna elements, for example, dipole antennas 202 and 204 disposed to cross orthogonally with each other, as shown in FIG. 2. A high frequency signal received by each dipole antenna is applied through level adjusting means, e.g., variable attenuator 206, 208 to a combiner 210, where the two signals are combined with each other. The amounts of attenuation given by the variable attenuators 206 and 208 are externally remote-controlled to thereby change the combined directivity direction of the two dipole antennas 202 and 204 stepwise by a predetermined angle of, for example, 22.5 degrees, along a circumference of a circle centered about the intersection of the dipole antennas 202 and 204, as shown in FIG. 3. With this arrangement, the combined directivity can be changed to any one of different sixteen (16), for example, directions a through p. The variable directivity antenna 2 is a wide band antenna capable of receiving all UHF-band terrestrial digital broadcast signals.

The variable directivity antenna 2 includes therein amplifying means, e.g. high frequency amplifiers 212 and 214. Bypass switches 216 and 218 are externally remote-controlled to cause the UHF-band high frequency signals received by the dipole antennas 202 and 204 to be applied through the high frequency amplifiers 212 and 214, respectively, or directly, to the variable attenuators 206 and 208.

The UHF-band high frequency signals from the variable directivity antenna 2 are applied through a control box 4 to a set-top box 6. The control signal for varying the directivity and the control signal for applying the high frequency signals to the amplifiers 212 and 214 or bypassing them around the amplifiers 212 and 214 are generated in the set-top box 6 and supplied through the control box 4 to the variable directivity antenna 2. The variable directivity antenna 2 and the control box 4 are connected by one coaxial cable in practice, through which the high frequency signal and the control signals are transferred. Power for operating the high frequency amplifiers 212 and 214 in the variable directivity antenna 2 is supplied from the set-top box 6 to the control box 4, from which power is supplied through the coaxial cable to the variable directivity antenna 2. In order to make it possible to provide power and control signals to the variable directivity antenna 2 the control signals are modulated in the control box 4. The control box 4 is for the purpose of modulation. Therefore, when the control signals and power are arranged to be separately supplied from the set-top box 6, the control box 4 can be eliminated. Alternatively, a circuit having a function which the control box 4 performs can be placed in the set-top box 6. In this case, a cable connecting the control box and the set-top box 6 is not required.

The set-top box 6 includes therein a tuner 8, to which UHF-band high frequency signals from the control box 4 are applied. The tuner 8 includes tuning means, e.g. a tuned circuit, for selecting a terrestrial digital broadcast signal of a desired frequency band or channel, from the UHF-band high frequency signals. The tuned circuit is arranged such that the terrestrial digital broadcast channel to be selected by the tuned circuit can be changed. The tuner 8 converts the terrestrial digital broadcast signal of the selected channel to an intermediate frequency signal and then demodulates it to a baseband signal, before supplying it to a television receiver. The tuner 8 is also provided with level detecting means for detecting a signal level of a terrestrial digital broadcast signal of a selected channel, or its intermediate frequency version, or a baseband signal resulting from transforming the intermediate frequency signal. The level detecting means may be, for example, a level detecting circuit 9 for detecting a peak level within a predetermined time period. A detected-level representative signal from the level detecting circuit 9 is applied to a control unit 10. The tuner 8 includes therein amplifying means, e.g. a high-frequency amplifier 80.

The control unit 10 includes control means, e.g. a CPU 12, and memory means, e.g. a ROM 14 and a RAM 16. Programs for operating the CPU 12 and data required for the CPU 12 to operate are stored in the ROM 14. The RAM 16 operates as a work area for the operation of the CPU 12. The CPU 12 receives a channel selection signal from operating means, e.g., a remote control transmitter (not shown). The CPU 12 operates, in accordance with instructions given on the channel selection signal, to switch the channel to be selected in the tuner 8 and, also, to supply required control signals to the control box 4 through an interface 18 in order to direct the directivity of the variable directivity antenna 2 to the direction in which the terrestrial digital broadcast signal of the selected channel can be received. A power supply unit 20 supplies power necessary for operating the control unit 10, the tuner 8, and the high frequency amplifiers in the variable directivity antenna 2.

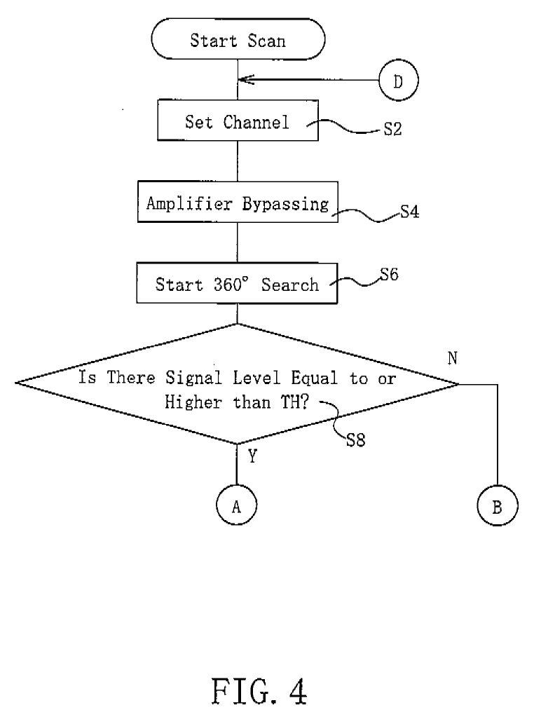

As described above, in the described signal receiving system, when the channel selection signal representative of the terrestrial digital broadcast signal of desired channel is sent from the remote control transmitter, the directivity of the variable directivity antenna 2 need be directed to the direction from which the desired terrestrial digital broadcast signal wave comes. For that purpose, when the signal receiving system is installed on the desired site, the control unit 10 executes direction determining processing shown in FIGS. 4-5 and FIGS. 8-10.

In this processing, the control unit 10 first sets the tuner 8 to receive a signal of one of terrestrial digital broadcast channels to be received (Step S2). Next, the control unit 10 causes an amplifier-bypassing step to be taken (Step S4). In this amplifier-bypassing step, the variable directivity antenna 2 is supplied with such a control signal as to make the high frequency signals as received by the dipole antennas 202 and 204 bypass the high frequency amplifiers 212 and 214, respectively, so that they are not amplified in the amplifiers. Then, the direction of the directivity of the variable directivity antenna 2 is changed, starting from the reference direction a, successively by an angle of 22.5 degrees, and the detected-level representative signals developed by the level detecting circuit 9 for the respective directions are supplied to the control unit 10 where they are stored together with the associated directions (Step S6) Then, a judgment is made as to whether there is a detected-level representative signal equal to or higher than a threshold TH, which is the level required for a terrestrial digital broadcast signal to be satisfactorily received (Step S8) In other words, a judgment is made as to whether the terrestrial digital broadcast signal of the selected channel is being received satisfactorily without resort to the amplification in the high frequency amplifiers 212 and 214. The threshold level TH is preset.

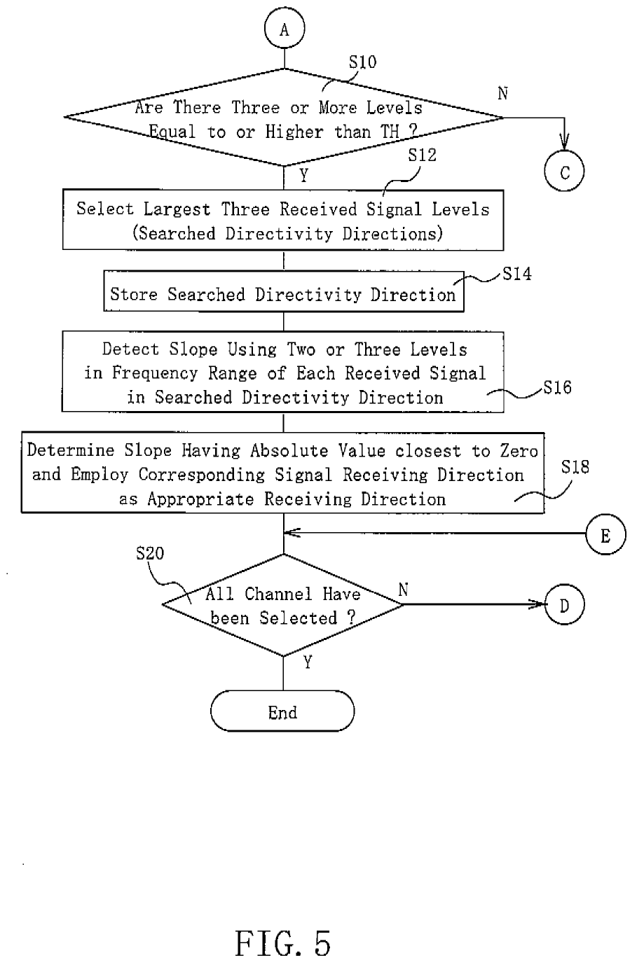

If the answer to the query in Step S8 is YES, a judgment as to whether there are a predetermined number, e.g. three or more, received signal levels equal to or above the threshold TH is made (Step S10), as shown in FIG. 5. This judgment is for determining whether the terrestrial digital broadcast signal of the selected channel is being received in two or more directions, other than the true signal receiving direction, due to influences of multiple signal paths etc. If the selected channel signal is being received from three or more directions, the largest three reception levels among them equal to or higher than the threshold level TH are selected (Step S12), whereby the received signal levels in three of the directions shown in FIG. 3 are selected, for example. Hereinafter, such selected directivity directions are referred to as searched directivity directions.

These search directivity directions are stored (Step S14). Next, a slope between two or three levels of the respective received signals received from these searched directivity directions (Step S16). A slope of which absolute value is closest to zero (0) is selected from the slopes, and the signal receiving direction for the selected slope is determined to be the signal receiving direction (Step S18).

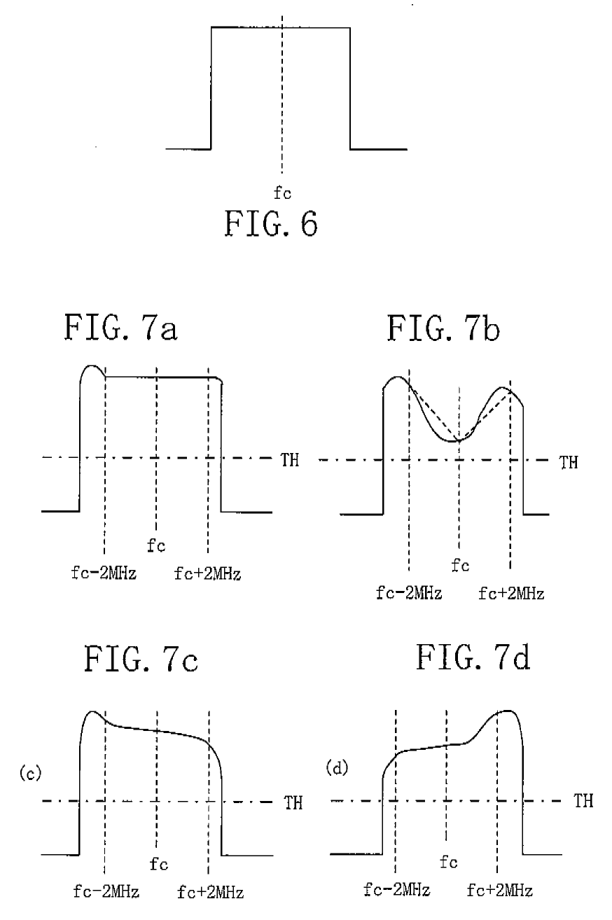

For example, the basic waveform of a baseband terrestrial digital television broadcast signal exhibits substantially constant received signal level over the entire frequency range (e.g. 6 MHz), as shown in FIG. 6. Accordingly, when the directivity of the variable directivity antenna 2 is in alignment with the direction from which the terrestrial digital television broadcast wave is coming to the antenna, the waveform of the received and demodulated baseband terrestrial digital television broadcast signal shown in FIG. 7a is similar to the basic waveform shown in FIG. 6. If, on the other hand, although the directivity direction of the variable directivity antenna 2 is oriented to a direction different from the direction from which the correct terrestrial digital television broadcast signal wave, there is a received signal level equal to or larger than the threshold level TH, the waveform of the received and demodulated baseband terrestrial digital television broadcast signal may not be constant over the frequency range, but dips in its central portion, as is shown in FIG. 7b, because of multi-path influence etc. In other case, as shown in FIG. 7c, a maximum received signal level may be exhibited in a lower frequency area of the frequency range, with the received signal level decreasing as the frequency rises. In still other case, as shown in FIG. 7d, a maximum received signal level may be exhibited in a higher frequency area of the frequency range, with the received signal level decreasing as the frequency decreases,

Therefore, the received signal levels at predetermined frequencies above and below the center frequency fc of the frequency range, for example, at frequencies of fc ±2 MHz, are detected. Such is possible by finely tuning the tuned frequency in the tuner 8. Then, the slope between the detected two received signal levels is calculated. Specifically, the slope can be obtained by dividing the difference between the two received signal levels by 4 MHz, which is the difference between the frequencies fc ±2 MHz. The signal receiving direction for the smallest one of the thus obtained three slopes, e.g. the slope closest to zero (0), or, in other words, the signal receiving direction providing the received signal level characteristic shown in FIG. 7a, for example, is determined as the signal receiving direction. In order to obtain the two received signal levels the slope between which is to be calculated, the received signal level at each of the frequencies fc ±2 MHz is detected plural times, and the average of the received signal levels at fc +2 MHz and the average of the received signal levels at fc −2 MHz are used.

If the waveform has a dip in the center portion like the one shown in FIG. 7b, the calculated slope would not be so large when the slope is calculated using the frequencies of fc ±2 MHz despite the presence of the center dip. In order to avoid such disadvantage, it may be arranged to detect the received signal level at fc, in addition to the received signal levels at the frequencies of fc ±2 MHz, to determine the slope between the received signal level at fc −2 MHz and the received signal level at fc and the slope between the received signal level at fc +2 MHz and the received signal level at fc, and to employ the direction for the absolute values of the two slopes closest to zero (0) as the correct signal receiving direction.

The system may be arranged such that either one of the described calculations can be employed so that a user can choose either one depending on his or her desire. It may be arranged that, if satisfactory signal reception cannot be achieved by determining the signal receiving direction based on the determination of the slopes using two frequencies, fc ±2 MHz, the signal receiving direction is determined anew based on the detection of the slope between fc −2 MHz and fc and the slope between fc +2 MHz and fc.

Slopes may be calculated for all of the received signal levels equal to or higher than the threshold level TH, to employ the direction for the slope having an absolute value closest to zero (0) as the appropriate signal receiving direction. However, this method may require a longer time for determination of the antenna directivity orientation. Therefore, according to the described embodiment, only the highest three received signal levels are used. It should be noted, however, that the number of received signal levels used need not be three, but the number can be any number equal to or larger than two (2) and not greater than the total received signal levels, which is determined taking the time permitted to be spent for the direction determination.

When the direction for one channel is determined in the manner described above, a judgment is made as to whether the direction setting has been completed for all of the channels (Step S20), and if the judgment is affirmative, the processing for determining the signal receiving directions is ended. If the answer to the query in Step S20 is NO, a new channel is designated in Step S2 in the flow chart shown in FIG. 4, and the processing described above is repeated.

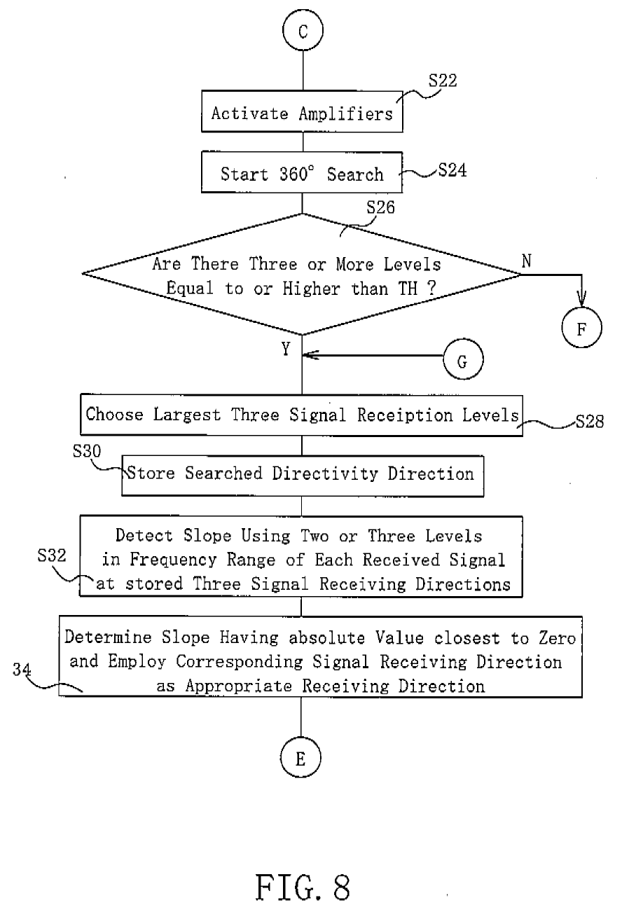

If a judgment that there are less than three signal levels equal to or higher than the threshold level TH, is made in Step S10, an amplifier activating operation is initiated so that the received high frequency signal can be amplified in the high frequency amplifiers within the variable directivity antenna 2 (Step S22), as shown in FIG. 8. This operation is for increasing the possibility of increasing the number of the signal receiving levels equal to or above the threshold TH to three or more. Thereafter, as in Step S6, the signal reception levels for the respective directions are stored, being correlated with the associated directions (Step S24), and, as in Step S10, a judgment is made as to whether there are three or more signal reception levels equal to or higher than the threshold TH (Step S26). If it is judged that there are three or more signal reception levels equal to or above TH, processing as executed in Steps S12, S14, S16 and S18 is executed in Steps S28, S30, S32 and S34, to thereby determine the direction for the selected channel followed by the processing of Step S20. Then, the determination of the direction for a next channel is executed.

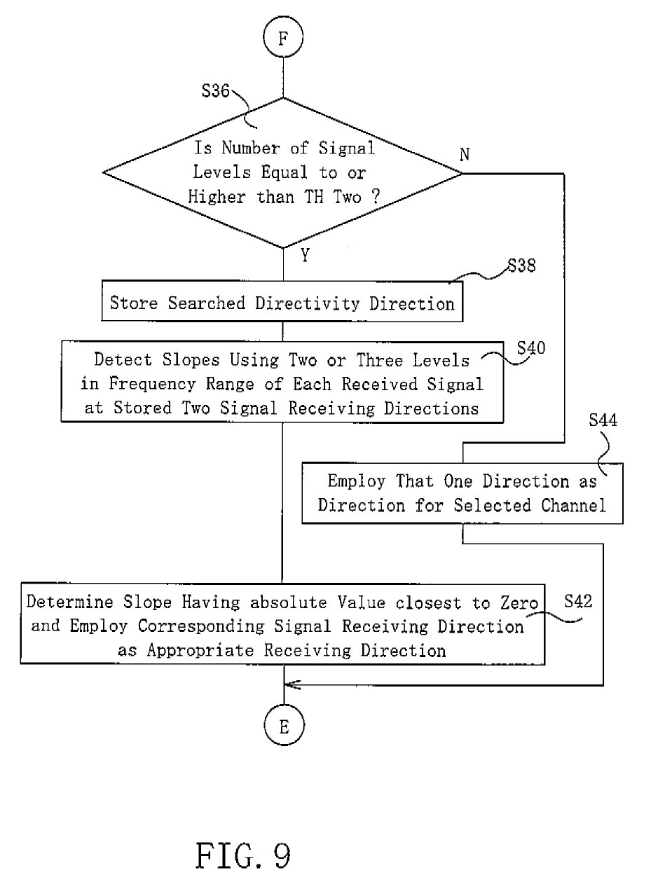

If it is judged, in Step S26, that the number of signal receiving levels equal to or higher than the threshold TH is less than three, a judgment is made as to whether the number of signal receiving levels equal to or higher than the threshold TH is two (Step S36) as shown in FIG. 9. If the answer to this question is YES, the processing as executed in Steps S14, S16 and S18 is executed, in Steps S38, S40 and S42, for the signal reception levels for the directions on opposite sides of each of the two searched directivity directions, whereby the direction for the selected channel is determined. Then, Step S20 is executed, and the determination of the direction for a next channel is executed.

If it is judged, in Step S36, that the number of received signal levels equal to or higher than the threshold level TH is not two, meaning that there is only one received signal level which is equal to or higher than TH, the direction providing that received signal level is employed as the direction for the selected channel (Step S44), and Step S20 is executed. After that, the determination of the direction for a next channel is executed.

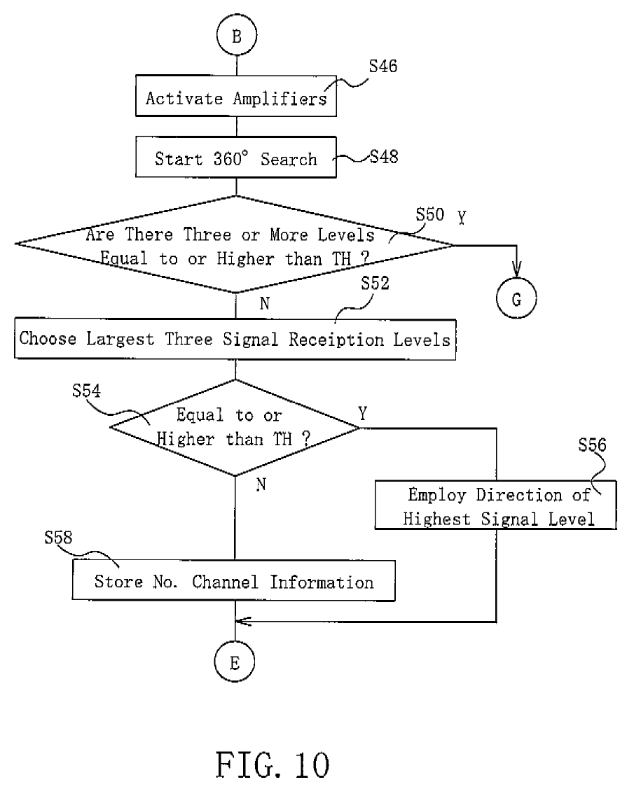

If it is judged, in Step S8, that no received signal level equal to or higher than the threshold level TH is present, the amplifier activating operation is initiated (Step S46), as done in Step S22, as shown in FIG. 10, and the signal reception levels for the respective directions are stored together with the associated directions (Step S48), as done in Step S6. Thereafter, a judgment is made, as done in Step S10, as to whether there are three or more received signal levels equal to or higher than the threshold level TH (Step S50). If the answer to this question is YES, the processing as executed in Step S28 and the succeeding steps is executed.

If it is judged, in Step S50, that there are less than three received signal levels equal to or higher than the threshold level TH, the highest three of the signal reception levels are selected (Step S52). In other words, as done in Step S6, the directivity direction of the variable directivity antenna 2 is successively changed, and the signal reception level for each direction is measured. This procedure is taken plural times, and the signal reception levels measured for each direction are averaged. Then, the largest three averages are selected. Then, a judgment is made as to whether there are signal reception levels, in the selected three signal reception levels, equal to or higher than the threshold level TH (Step S54). The judgment in Step S54 is executed, since there is a possibility that a received signal level equal to or higher than the threshold level TH may result from the execution of Step S52 If the answer to the question made in Step S54 is YES, the direction in which the highest one of the signal reception levels equal to or higher than the threshold level TH results is employed as the direction for that channel (Step S56). On the other hand, if the answer to the question made in Step S54 is NO, meaning that no signal wave can be received, no direction for the selected channel is stored (Step S58). Then, Step S20 is executed, and the determination of the direction for the next channel is initiated.

The present invention has been described, being embodied in a terrestrial digital broadcast signal receiving system, but the invention is not limited to such system. The invention can be embodied in satellite broadcast signal receiving system or satellite communication receiving systems, for example. In the described embodiment, Step S46 and subsequent steps are executed when the answer to the query in Step S8 is NO, but, in such case, it may be arranged such that no direction for the selected channel can be stored, as in Step S58. Also, when the answer to the query made in Step S10 is NO, Step S26 and subsequent steps may be executed, keeping the high frequency amplifiers bypassed. In the described embodiment, slopes are calculated by determining the received signal levels at frequencies of the center frequency plus and minus 2 MHz, but the invention is not limited to it. For example, the maximum and minimum of the received signal levels within the frequency range of a particular received and demodulated terrestrial digital broadcast signal may be determined for calculating the slope between them. Further, although the high-frequency amplifiers 212 and 214 within the variable directivity antenna 2 are turned on in the above-described embodiment, but the amplifier 80 in the tuner 8 may be turned on instead.

What is claimed is:

1. A signal receiving system comprising:
a variable directivity antenna having a direction of directivity variable stepwise along a circumference of a circle about itself;
signal receiving means for selectively receiving a desired one of high frequency signals having a given frequency range received by said variable directivity antenna;
level detecting means for detecting a level of a signal received by said signal receiving means;
searching means for searching those ones of levels of said received signal received by said signal receiving means in plural states of said variable directivity antenna with different directions of directivity thereof, which are equal to or higher than a predetermined threshold level;
slope detecting means for detecting a slope between a plurality of received signal levels within the frequency range of each searched received signal; and
determining means for employing said searched directivity direction corresponding to the smallest one of the detected slopes, as the signal receiving direction for said variable directivity antenna.

2. The signal receiving system according to claim 1I, wherein said slope detecting means detects a slope using received signal levels on opposite sides of a center frequency of said frequency range.

3. The signal receiving system according to claim 1, wherein, when there are a predetermined number or more received signal levels equal to or higher than said threshold level, said slope detecting means detects a slope, using a predetermined number of received signals having a level equal to or higher than said threshold level selected in the order of magnitude of signal level, the highest one first.

4. The signal receiving system according to claim 1, wherein said signal receiving means or said variable directivity antenna includes amplifying means operable when no received signal level is equal to or higher than said threshold level.

5. The signal receiving system according to claim 1, wherein said signal receiving means or said variable directivity antenna includes amplifying means operable when there are less than a predetermined number of signal levels equal to or higher than said threshold level.
